(19) United States
(12) Patent Application Publication
(10) Pub. No.: US 2016/0274946 A1
(43) Pub. Date: Sep. 22, 2016

(54) SYSTEM AND METHOD FOR CONTROLLING WORKFLOW EXECUTION, AND RECORDING MEDIUM

(71) Applicant: Kensuke TANAKA, Kanagawa (JP)

(72) Inventor: Kensuke TANAKA, Kanagawa (JP)

(73) Assignee: Ricoh Company, Ltd., Tokyo (JP)

(21) Appl. No.: 15/068,735

(22) Filed: Mar. 14, 2016

(30) Foreign Application Priority Data
Mar. 20, 2015 (JP) 2015-058819

(51) Int. Cl. G06F 9/50; G06K 9/00; G06F 3/12

(52) U.S. Cl. CPC G06F 9/5038; G06F 9/5083; G06F 3/1208; G06F 3/1275; G06F 3/1263; G06K 9/00442; G06K 2209/01

(57) ABSTRACT

A workflow execution control system includes a job queue server and a plurality of distribution servers. The job queue server is configured to store a plurality of jobs in a memory. Each distribution server is set with job acquisition setting. Each distribution server is configured to acquire one of the plurality of jobs from the job queue server based on a determination of whether the job acquisition setting indicates that the job queue server is a job queue server that the distribution server is to acquire the job from; determine whether a predetermined job is included in the acquired job according to the job acquisition setting indicating the predetermined job to be processed by the distribution server; and execute the predetermined job based on a determination indicating that the acquired job includes the predetermined job.

### CROSS-REFERENCE TO RELATED APPLICATIONS

This patent application is based on and claims priority pursuant to 35 U.S.C. §119(a) to Japanese Patent Application No. 2015-058819, filed on Mar. 20, 2015, in the Japan Patent Office, the entire disclosure of which is hereby incorporated by reference herein.

### BACKGROUND

1. Technical Field

The present disclosure relates to a system and a method for controlling workflow execution, and a non-transitory recording medium.

2. Description of the Related Art

Workflow execution apparatuses are known, which execute a workflow such as a document distribution workflow for distributing a generated or edited document to a predetermined destination. It often takes a long time for such workflow execution apparatuses to execute image processes such as optical character reader (OCR) processing. In order to balance loads, a system is known, which includes a plurality of servers that operate in cooperation with one another to share processing tasks therebetween and efficiently execute the image processing.

### SUMMARY

A workflow execution control system includes a job queue server and a plurality of distribution servers. The job queue server is configured to store a plurality of jobs in a memory. Each distribution server is set with job acquisition setting. Each distribution server is configured to acquire one of the plurality of jobs from the job queue server based on a determination of whether the job acquisition setting indicates that the job queue server is a job queue server that the distribution server is to acquire the job from; determine whether a predetermined job is included in the acquired job according to the job acquisition setting indicating the predetermined job to be processed by the distribution server; and execute the predetermined job based on a determination indicating that the acquired job includes the predetermined job.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a workflow execution system according to an exemplary embodiment of the present invention;

FIG. 2 is a block diagram illustrating an exemplary hardware configuration of a distribution server of the workflow execution system of FIG. 1;

FIG. 3 is a block diagram illustrating a functional configuration of the workflow execution system of FIG. 1 according to the exemplary embodiment of the present invention;

FIG. 4 is a flowchart illustrating exemplary operation executed by the workflow execution system of FIG. 3;

FIG. 5 is a block diagram illustrating an exemplary modified functional configuration of the workflow execution system of FIG. 3;

FIG. 6 is a flowchart illustrating exemplary modified operation executed by the workflow execution system of FIG. 3;

FIG. 7 is a block diagram illustrating a functional configuration of a workflow execution system according to a further exemplary embodiment of the present invention;

FIG. 8 is a flowchart illustrating exemplary operation executed by the workflow execution system of FIG. 7;

FIG. 9 is an illustration for explaining accessing a job queue server by a plurality of document distribution servers constituting a workflow execution system, each document distribution server having corresponding plug-ins, according to an exemplary embodiment of the present invention;

FIG. 10 is an illustration for explaining a plug-in configuration, a workflow configuration, and a document distribution server undertaking processing to be executed by a plug-in in a workflow execution system according to an exemplary embodiment of the present invention;

FIG. 11 is an exemplary illustration for explaining types of job queue servers accessed by a document distribution server according to an exemplary embodiment of the present invention;

FIG. 12 is an exemplary illustration for explaining a plug-in configuration, a workflow configuration, and a document distribution server undertaking processing to be executed by a plug-in in in a workflow execution system according to a further exemplary embodiment of the present invention;

FIG. 13 is an exemplary illustration for explaining types of queue servers accessed by a document distribution server according to a further exemplary embodiment of the present invention;

FIG. 14 is a flowchart illustrating an exemplary operation performed by the document distribution server A and the document distribution server B according to a further exemplary embodiment of the present invention;

FIG. 15 is a flowchart illustrating an exemplary operation performed by the document distribution server A according to a further exemplary embodiment of the present invention;

FIG. 16 is a flowchart illustrating an exemplary operation performed by the document distribution server A according to a further exemplary embodiment of the present invention;

FIG. 17 is a flowchart illustrating an exemplary operation performed by the document distribution server A according to a further exemplary embodiment of the present invention, and

FIG. 18 is a flowchart illustrating an exemplary operation performed by the document distribution server A according to a further exemplary embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

An exemplary embodiment of the present invention will be described hereinafter with reference to drawings. In the drawings, the identical or corresponding parts are denoted by the same reference numbers. Explanation will be omitted or simplified of the configurations and function of these parts. In an exemplary embodiment described below, explanation will be made of a workflow execution system including two distribution servers. Alternatively, the system may include any arbitrary number of distribution servers.

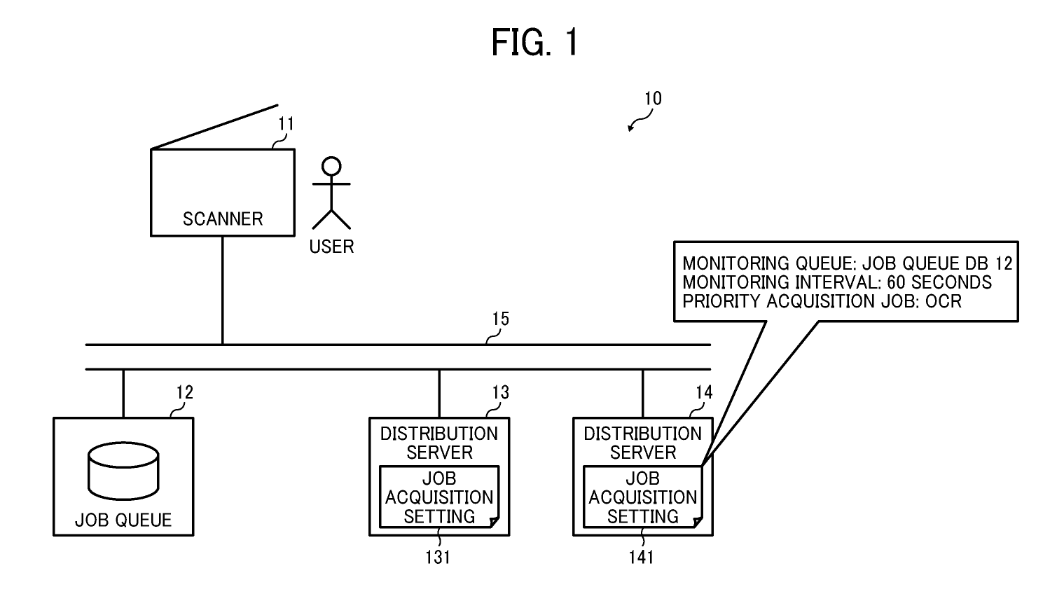

First, explanation will be made of an overview of a workflow execution system according to an exemplary embodiment of the present invention. FIG. 1 is a schematic diagram illustrating a system configuration of a workflow execution system 10 according to an exemplary embodiment of the present invention.

As illustrated in FIG. 1, the workflow execution system 10 includes a scanner 11, a job queue database (DB) 12, which is an example of a storage device, a distribution server 13, and a distribution server 14, which are coupled to one another via a network 15. The distribution servers 13 and 14 respectively include job acquisition settings 131 and 141. In this embodiment, the job queue DB 12 is provided at a location that can be accessed by the distribution servers 13 and 14 to refer to the job queue DB 12. In FIG. 1, the job queue DB 12 is provided in a server that is independent from the distribution servers 13 and 14. Alternatively, the job queue DB 12 may be provided in either one of the distribution servers 13 and 14.

The distribution servers 13 and 14 respectively include the job acquisition settings 131 and 141 to be used for acquiring a job from the job queue DB 12. Each of the job acquisition settings 131 and 141 is set with a job queue to be monitored, a monitoring interval, and an option item such as a priority in acquiring a job. In this embodiment illustrated in FIG. 1, the job acquisition setting 141 of the distribution server 141 sets the job queue DB 12 as the job queue to be monitored. Further, the job acquisition setting 141 sets the monitoring interval to 60 seconds. The monitoring interval is a time interval during which the distribution server 14 monitors to detect any job to be acquired from the job queue DB 12.

In other words, when the distribution server is processing a job, the distribution server 14 waits until the job is completed before acquiring another job from the job queue DB 12. The distribution server 14 periodically monitors the job queue DB 12 at the monitoring intervals while the distribution server 14 is in an idle status. The job acquisition setting 141 sets the OCR as the priority acquisition job. The priority acquisition job, a high-priority job to be acquired, is a job that causes the distribution server 14 to execute a specific processing. The distribution server 14 acquires the priority acquisition job prior to other jobs. Accordingly, the distribution server 14 executes the OCR processing, which is set as the priority acquisition job in the job acquisition setting 141, prior to other processing, because the OCR processing is time-consuming as described later.

The job acquisition setting 131 of the distribution server 13 may or may not set the priority acquisition job. The distribution servers 13 and 14 may respectively set with the job acquisition settings 131 and 141 in advance.

When the scanner 11 scans a document image in response to an instruction input by a user, a scan job is generated. The generated scan job is stored in the job queue DB 12, which is designated in advance. In other words, when the user causes the scanner 11 to scan the image data and designates a workflow for processing the scanned image data, the scanned image data and information on the workflow to be executed are stored in the job queue DB 12. The distribution servers 13 and 14, each serving as a node, acquire the scan job in accordance with the job acquisition settings 131 and 141, respectively, when the distribution servers 13 and 14 are in an idle status.

The workflow herein means a series of processes to be performed on a specific document. Specifically, the workflow may include the OCR processing, a portable document format (PDF) processing, a noise removal processing, an image correction processing, and/or a barcode reading processing.

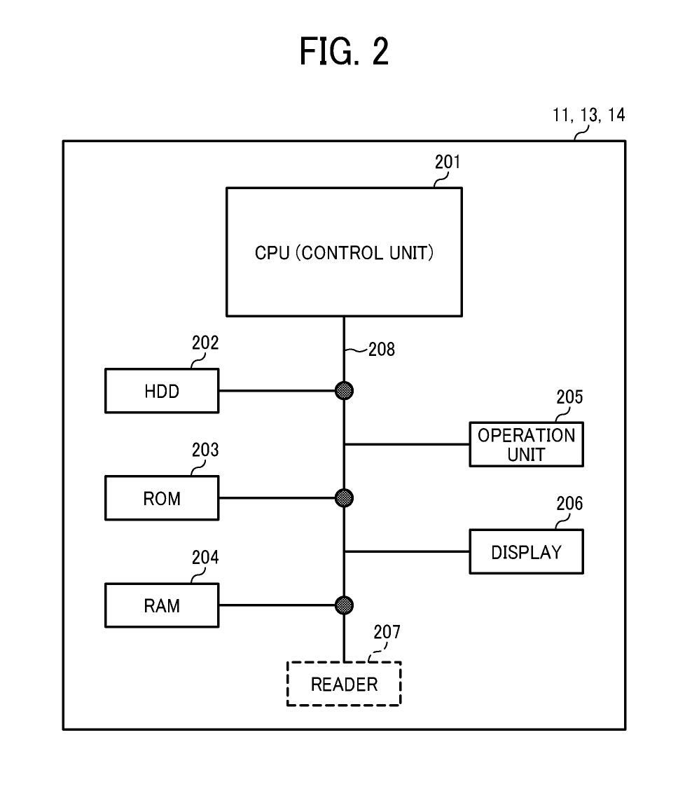

Hereinafter, explanation will be made of exemplary configurations of the scanner device 11 and the distribution servers 13 and 14 of the workflow execution system 1 according to an embodiment of the present invention. FIG. 2 is a block diagram illustrating an exemplary hardware configuration of an information processing apparatus serving as the distribution server 13 or 14. The information processing apparatus may be implemented by a general-purpose computer.

As illustrated in FIG. 2, the information processing apparatus includes a central processing unit (CPU) 201 as a control unit. The CPU 201 controls entire operation of the information processing apparatus. The information processing apparatus further includes a read only memory (ROM) 203 and a random access memory (RAM) 204. The ROM 203 stores a program executed by the CPU 201. The RAM 204 temporarily stores computation data processed by the CPU 201.

The information processing apparatus further includes an operation unit 205 and a display 206. The operation unit 205 allows the user to input an instruction to the information processing apparatus, such as a keyboard, a mouse, or a touch panel. The display 206 is an interface that interacts with the user, for example, by displaying information. The display 206 may be implemented by a liquid crystal display, for example. The information processing apparatus further includes a hard disk drive (HDD) 202, which stores a result of the job executed by the information processing apparatus. The CPU 201, the HDD 202, the ROM 203, the RAM 24, the operation unit 205, and the display 206 are coupled to one another via a bus 208.

The scanner 11 is substantially similar in hardware configuration to the information processing apparatus of FIG. 2, at least for a control section. The scanner 11 further includes dedicated hardware such as a reader 207 that reads a document into image data.

The job queue DB 12 is implemented by any memory such as a HDD.

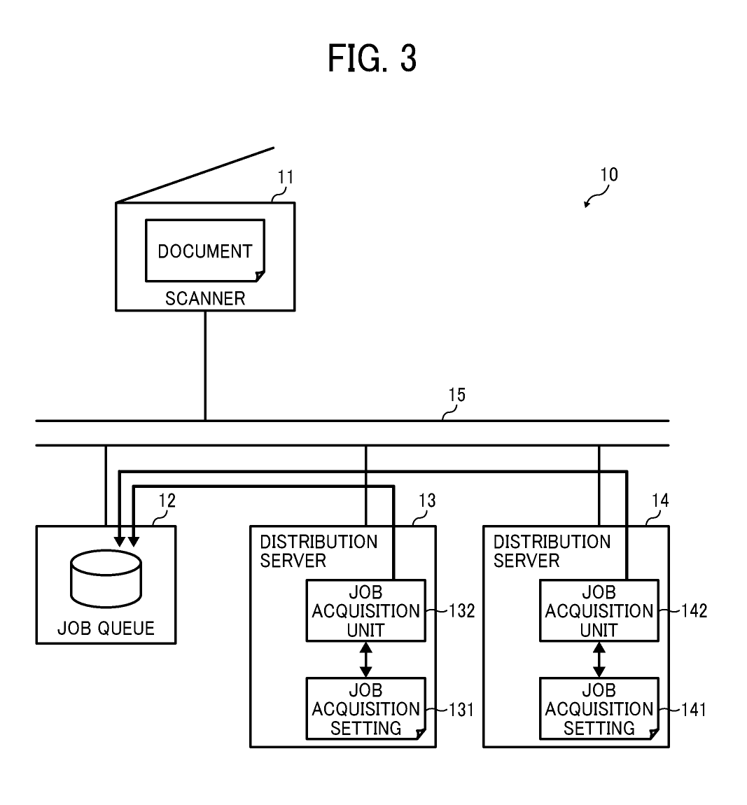

Hereinafter, explanation will be made of a configuration of the workflow execution system 10 according to an exemplary embodiment of the present invention. FIG. 3 is a block diagram illustrating a functional configuration of the workflow execution system 10 according to an exemplary embodiment of the present invention.

As described referring to FIG. 1, the distribution servers 13 and 14 respectively include job acquisition settings 131 and 141 to be used for acquiring the job. More specifically, the distribution servers 13 and 14 respectively store the job acquisition settings 131 and 141, in the respective memories (such as RAM 204). Further, the distribution servers 13 and 14 respectively include job acquisition units 132 and 142, implemented by the CPU 201 that operates according to the control program. In operation, when the scanner 11 scans a document image in response to an instruction input by a user, the scan job is stored in the designated job queue DB 12. Accordingly, the image data scanned by the scanner 11 accumulate in the job queue DB 12.

The job acquisition unit 132 and 142 respectively refer to the job acquisition settings 131 and 141 to acquire the scan job, for example, every predetermined time. In other words, the job acquisition units 132 and 142 acquire the image data and the workflow accumulated in the job queue DB 12. After acquiring the scan job, the document distribution servers 13 and 14 execute document distribution processing in accordance with the setting of the acquired scan job.

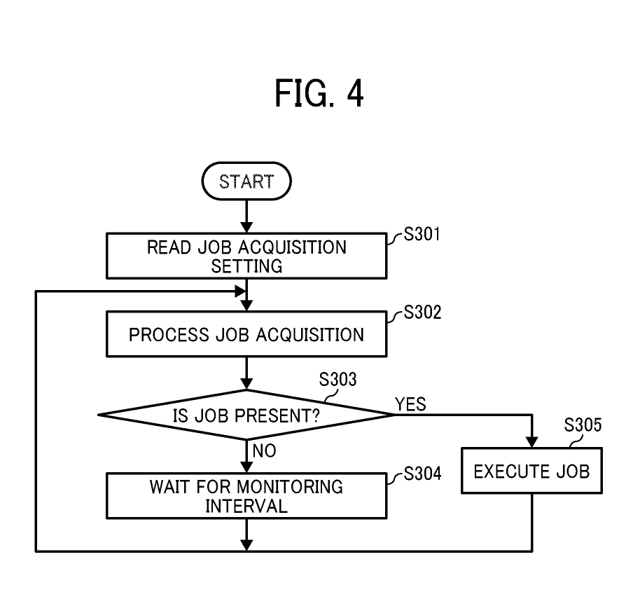

Hereinafter, explanation will be made of exemplary operation performed by the workflow execution system 10 according to an embodiment of the present invention. FIG. 4 is a flowchart illustrating operation of acquiring job (job acquisition processing) executed by the workflow execution system 10 according to an embodiment of the present invention. The operation of FIG. 4 is performed by the distribution server 13 or 14, according to the monitoring interval set with the job acquisition setting 131 or 141.

As illustrated in FIG. 4, the job acquisition units 132 and 142 respectively read the job acquisition settings 131 and 141 at S301. At S302, the job acquisition unit 132 performs job acquisition processing in accordance with the job acquisition setting 131, which is read at S301. Also, at S302, the job acquisition unit 142 performs job acquisition processing in accordance with the job acquisition setting 141, which is read at S301. In this example, it is assumed that both of the job acquisition settings 131 and 141 set the scan job as high-priority.

At S303, the job acquisition unit 132 and 142 each determines whether it has acquired the scan job at S302. When the job acquisition units 132 and 142 each determines that it has acquired the scan job (S303: YES), the processing proceeds to S305. At S305, the distribution servers 13 and 14 each executes the scan job in accordance with the setting of the scan job. Then, the processing returns to S302 to repeat the job acquisition processing.

When the job acquisition units 132 and 142 each determines that it has not acquired the scan job (S303: NO), the processing proceeds to S304. At S304, the job acquisition units 132 and 142 each waits until a time period set as the monitoring interval in respective ones of the job acquisition settings 131 and 141 has passed. Then, the processing returns 302 to repeat the job acquisition processing.

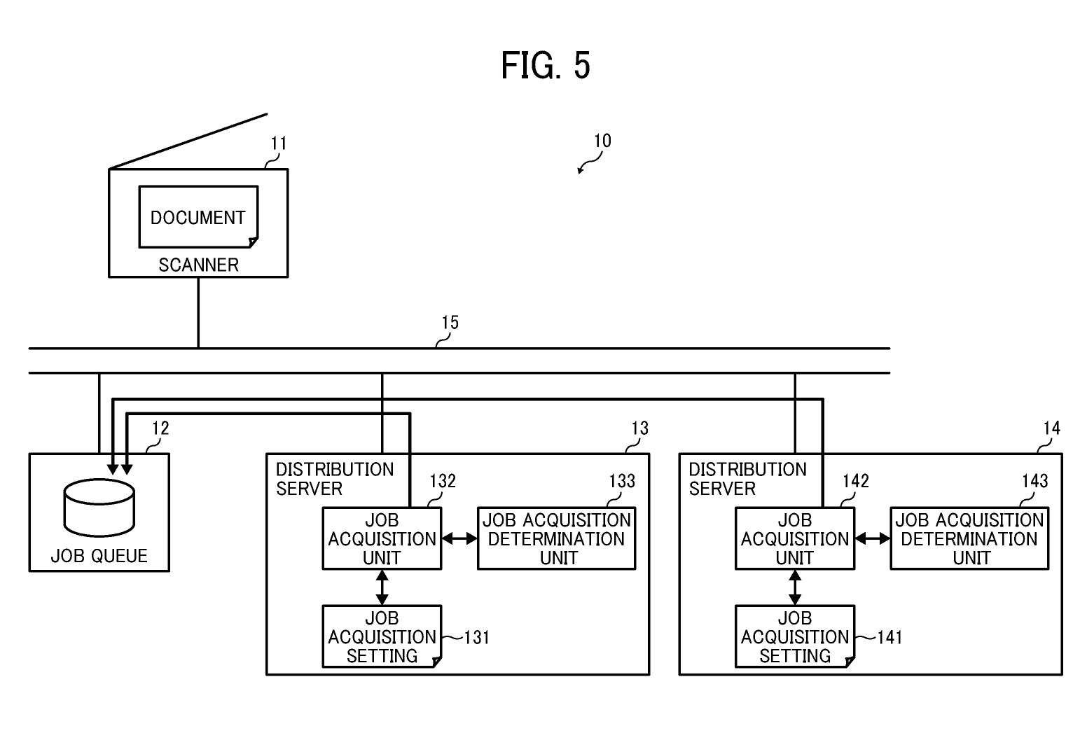

Hereinafter, explanation will be made of a function configuration of the workflow execution system 10 according to the modified example of FIG. 3. FIG. 5 is a block diagram illustrating a functional configuration of the workflow execution system 10, which is a modification of FIG. 3.

As illustrated in FIG. 5, in the workflow execution system 10 as modified, the distribution server 13 includes a job acquisition determination unit 133 in addition to the job acquisition setting 131 and the job acquisition unit 132. The distribution server 14 also includes a job acquisition determination unit 143 in addition to the job acquisition setting 141 and the job acquisition unit 142. The job queue DB 12 has a same configuration as that of FIG. 3.

When the scanner 11 scans a document image in response to an instruction input by a user, the scan job is stored in the designated job queue DB 12. The job acquisition units 132 and 142 respectively refer to the job acquisition settings 131 and 141 to acquire the scan job.

In a case where there are a plurality of scan jobs that are added to a queue data structure in the job queue DB 12 at the same time or nearly the same time, the job acquisition determination unit 133 determines whether the plurality of scan jobs include a scan job to be processed by the distribution server 13 prior to the other scan jobs. The job acquisition determination unit 143 also determines whether the plurality of scan jobs include a job to be processed by the distribution server 14 prior to the other scan jobs. When the job acquisition determination units 133 and/or 143 determine that the plurality of scan jobs include such scan job to be processed prior to the other scan jobs, the job acquisition units 132 and/or 142 acquire such job from the job queue DB 12. In response to the acquisition of the scan job, the document distribution servers 13 and 14 execute the document distribution processing in accordance with the setting of the acquired job. In the above determination as to whether there is the scan job to be processed prior to the other scan jobs, the job acquisition determination unit 133 determines to acquire the scan job that includes the OCR processing or an image conversion processing prior to the other scan jobs, in a case where the distribution server 13 includes hardware specific to image processing. In a similar manner, the job acquisition determination unit 143 also determines to acquire the scan job that includes the OCR processing or an image conversion processing prior the other scan jobs, in a case where the distribution server 14 includes hardware specific to image processing. The hardware specific to image processing may be, for example, an image processing circuit such as ASIC.

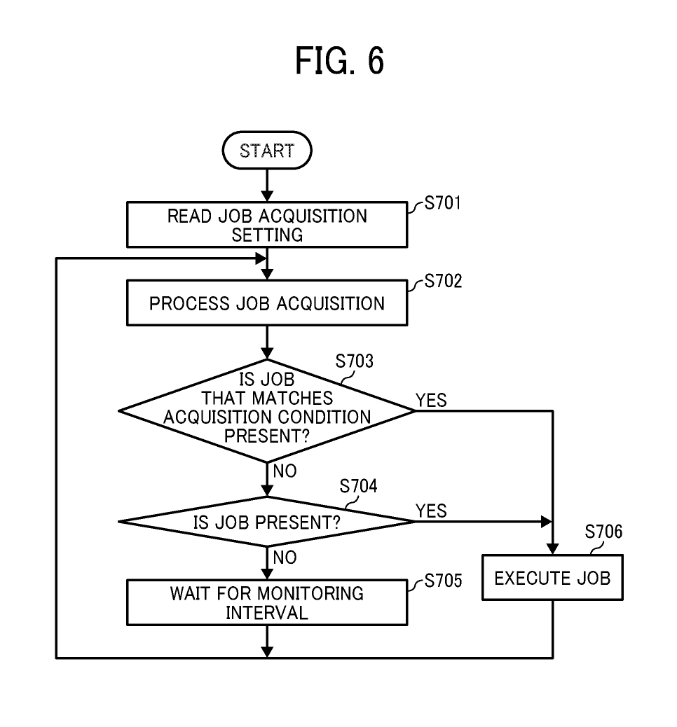

Hereinafter, explanation will be made of exemplary modified operation executed by the workflow execution system 10. FIG. 6 is a flowchart illustrating operation of acquiring job, executed by the workflow execution system 10 of FIG. 5, according to the modified example.

As illustrated in FIG. 6, when a job acquisition processing is started, the job acquisition units 132 and 142 respectively read the job acquisition settings 131 and 141 at S701. At S702, the job acquisition unit 132 performs job acquisition processing in accordance with the job acquisition setting 131, which is read at 701. Also, at S702, the job acquisition unit 142 performs job acquisition processing in accordance with the job acquisition setting 141, which is read at S701.

At S703, the job acquisition determination unit 133 determines whether, in the plurality of the scan jobs, there is a scan job that matches a job acquisition condition of the distribution server 13. Also, at S703, the job acquisition determination unit 143 determines whether, in the plurality of the scan jobs, there is a scan job that matches a job acquisition condition of the distribution server 14. In other words, as described above, the job acquisition determination unit 133 determines whether the plurality of jobs include a scan job that is to be processed by the distribution server 13 prior to the other scan jobs. The job acquisition determination unit 143 also determines whether the plurality of jobs include a scan job that is to be processed by the distribution server 14 prior to the other scan jobs.

When the job acquisition unit 132 and/or 142 determine that there is the scan job that matches the job acquisition condition (S703: YES), the processing proceeds to S706. When the job acquisition unit 132 and/or 142 determine that there is no scan job that matches the job acquisition condition (S703: NO), the processing proceeds to S704.

At S704, the job acquisition units 132 and 142 each determines whether, in the scan job acquired at S702, there is a scan job other than the scan job that matches the job acquisition condition. When the job acquisition units 132 and/or 142 determine that there is the scan job other than the scan job that matches the job acquisition condition (S704: YES), the processing proceeds to S706. When the job acquisition units 132 and/or 142 determine that there is no scan job other than the scan job that matches the job acquisition condition (S704: NO), the processing proceeds to S705.

At S706, the distribution servers 13 and 14 each executes the scan job in accordance with the setting of the scan job. Then, the processing returns to S702 to repeat the job acquisition processing. At S705, the job acquisition units 132 and 142 each waits until a time period set as the monitoring interval in respective ones of the job acquisition settings 131 and 141 has passed. Then, the processing returns to S702 to repeat the job acquisition processing.

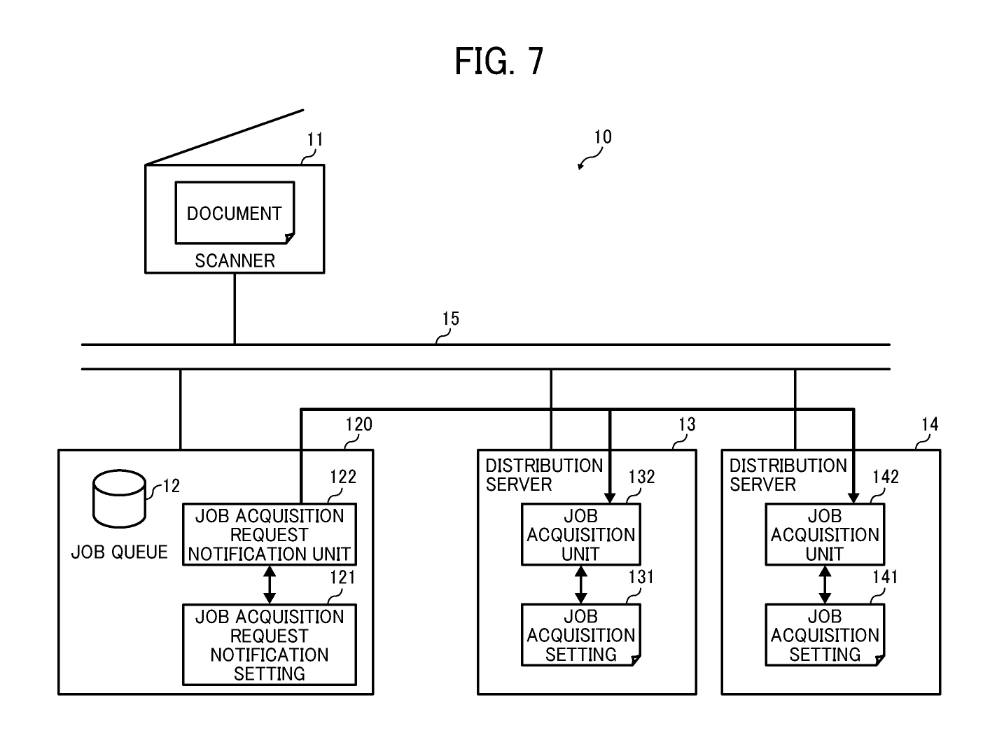

Hereinafter, explanation will be made of a function of the workflow execution system 10 according to a further exemplary embodiment of the present invention. FIG. 7 is a block diagram illustrating a functional configuration of the workflow execution system according to a further exemplary embodiment of the present invention.

As illustrated in FIG. 7, the workflow execution system 10 according to this embodiment includes a job queue server 120 including the job queue DB 12, a job acquisition request notification setting 121, and a job acquisition request notification unit 122. The distribution servers 13 and 14 each has a same configuration as that of FIG. 3. More specifically, the job queue server 120 may be implemented by the information processing apparatus, such as that of FIG. 2. The job acquisition request notification setting 121 and the job acquisition request notification unit 122 correspond to the instructions of the CPU 201 according to a control program stored in the memory such as the ROM 203.

When the scanner 11 scans a document image in response to an instruction input by a user, the scan job is stored in the designated job queue DB 12. The job acquisition units 132 and 142 respectively refer to the job acquisition settings 131 and 141 to acquire the scan job. In a case where no scan job is queued in the job queue DB 12, the job acquisition units 132 and 142 each waits until a set time period has passed.

In the above embodiment described with reference to FIGS. 3 to 6, in response to the addition of the scan job to a queue data structure in the job queue DB 12, the job acquisition units 132 and 142 do not acquire the scan job from the job queue DB 12. Instead, the job acquisition units 132 and 142 in the job acquisition execution processor 10 as described with reference to FIGS. 3 to 6 each waits until a time period set as the monitoring interval in respective ones of the job acquisition settings 131 and 141 has passed before acquiring the scan job from the job queue DB 12. It means that some settings of the monitoring interval may prevent the scan job from being acquired promptly or timely from the job queue DB 12.

In contrast, with the configuration of the workflow execution system 10 as illustrated in FIG. 7, the job acquisition request notification unit 122 refers to the job acquisition request notification setting 121 in response to the addition of the scan job to the queue data structure in the job queue DB 12. Then, the job acquisition request notification unit 122 sends a job acquisition request to the distribution servers 13 and 14, each being set as a destination of the job acquisition request notification by the job acquisition request notification setting 121.

In other words, the job queue server 120 sends a notification that requests the distribution servers 13 and 14 to acquire the scan job from the job queue DB 12 when the job queue is newly added in the job queue DB 12. In response to the acquisition of the job acquisition request from the job acquisition request notification unit 122, the distribution servers 13 and 14 perform the job acquisition processing in a substantially same manner as described with reference to FIG. 3.

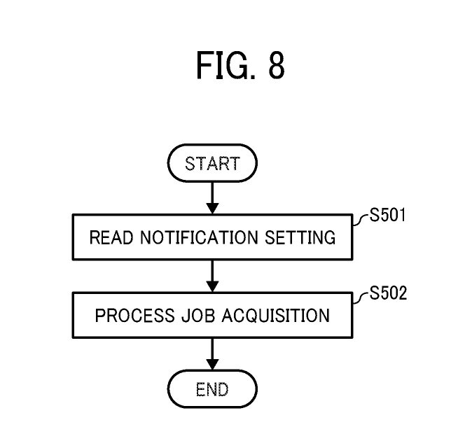

Hereinafter, explanation will be made of exemplary operation performed by the workflow execution system 10 according to a further embodiment of the present invention. FIG. 8 is a flowchart illustrating operation of sending notification to request for job acquisition executed by the workflow execution system 10 according to a further embodiment of the present invention.

As illustrated in FIG. 8, at S501, the job acquisition request notification unit 122 of the job queue server 120 reads the job acquisition request notification setting 121 in response to the addition of the scan job to the queue data structure in the job queue DB 12. In other words, the job acquisition request notification unit 122 reads the job acquisition request notification setting 121 at the timing when the job queue is registered with the job queue DB 12 of the job queue server 120.

At S502, the job acquisition request notification unit 122 sends a job acquisition request to the distribution servers 13 and 14, each being set as a destination by the job acquisition request notification setting 121, which is read at S501. Thus, the job acquisition request notification processing is completed. In response to the reception of the job acquisition request, the job acquisition units 132 and 142 starts the job acquisition processing as described above with reference to FIG. 4.

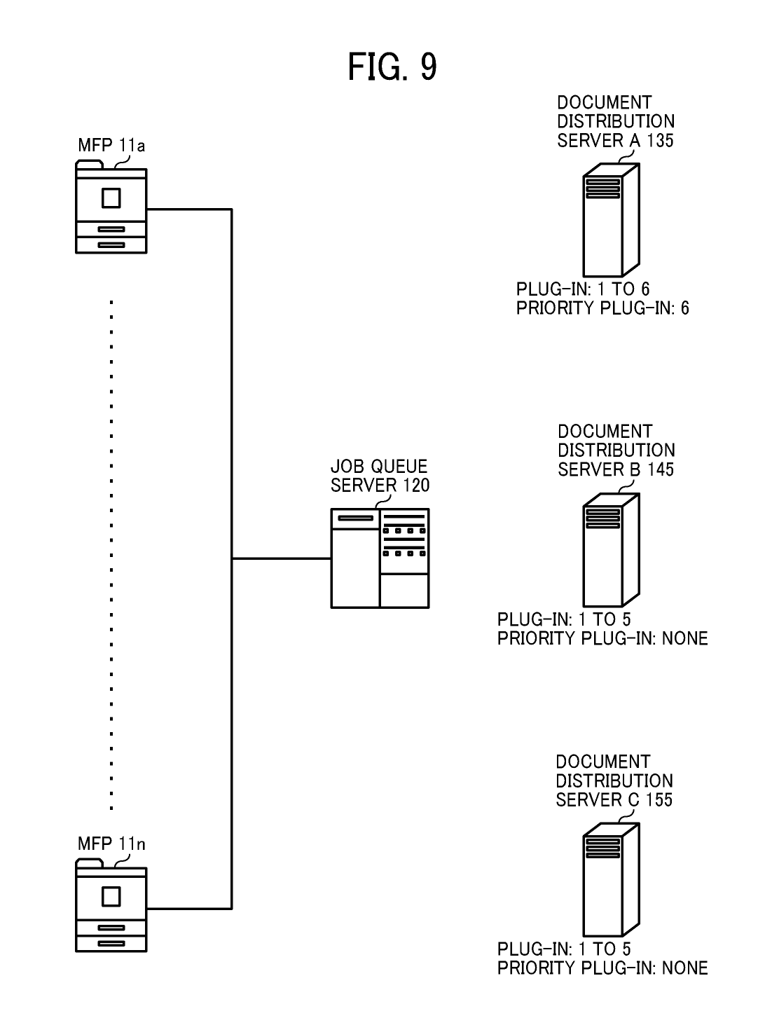

Hereinafter, explanation will be made of an exemplary configuration of the workflow execution system 10 including a job queue server that is accessed by a document distribution server installed with a plug-in according to an embodiment of the present invention. FIG. 9 is an exemplary illustration for explaining accessing the job queue server 120 by a plurality of document distribution servers A to C constituting the workflow execution system 10, each document distribution server A to C having plug-ins.

As illustrated in FIG. 9, the job queue server 120, which corresponds to the job queue DB 12 of FIG. 5, is coupled to a plurality of multifunction peripherals (MFPs) 11a to 11n, each corresponding to the scanner 11 of FIG. 5. The document distribution servers A to C acquire the job accumulated in the job queue server 120, and executes the acquired job. The document distribution server A corresponds to the distribution server 14 with the job acquisition setting 141, and the document distributions servers B and C correspond to the distribution server 13 with the job acquisition setting 131.

The document distribution server A includes plug-ins 1 to 6. The document distribution server A performs processing to be executed by the plug-ins 1 to 5 in a usual manner. The document distribution server A sets a job that instructs an execution of the workflow including the plug-in 6 as a priority plug-in, which corresponds to the priority acquisition job in the job acquisition setting explained above with reference to FIG. 1. In other words, the priority plug-in 6 is set as the priority job in the document distribution server A. A server like the document distribution server A is also referred to as a priority workflow execution processor (a first workflow execution processor with a priority setting). The document distribution servers B and C each include the plug-ins 1 to 5. The priority acquisition job is not set in the document distribution servers B and C. A server like the document distribution server B or C is also referred to as a normal workflow execution processor (a second workflow execution processor without the priority setting). In other words, the normal workflow execution processor is a workflow execution processor other than the priority workflow execution processor.

The term workflow herein means information for designating a series of desired plug-ins that are selected from the plug-ins 1 to 6 and set in a desired order, such that the information defines an execution content of processing. The term plug-in herein means a functional unit of an application program that executes processing. One or more plug-ins constitute the workflow. In other words, the plug-in provides individual commands to be executed in a functional set. In this embodiment, exemplary explanation will be made of six plug-ins, each being an element of processing units constituting the workflow. Alternatively, less or more than six plug-ins may be provided.

Referring to FIGS. 9 to 11, explanation will be made of a plug-in configuration, a workflow configuration, and the document distribution servers A and B undertaking processing to be executed by the plug-ins according to an exemplary embodiment of the present invention. Further, explanation will be made of types of the job queue servers accessed by the document distribution servers A and B according to the exemplary embodiment of the present invention.

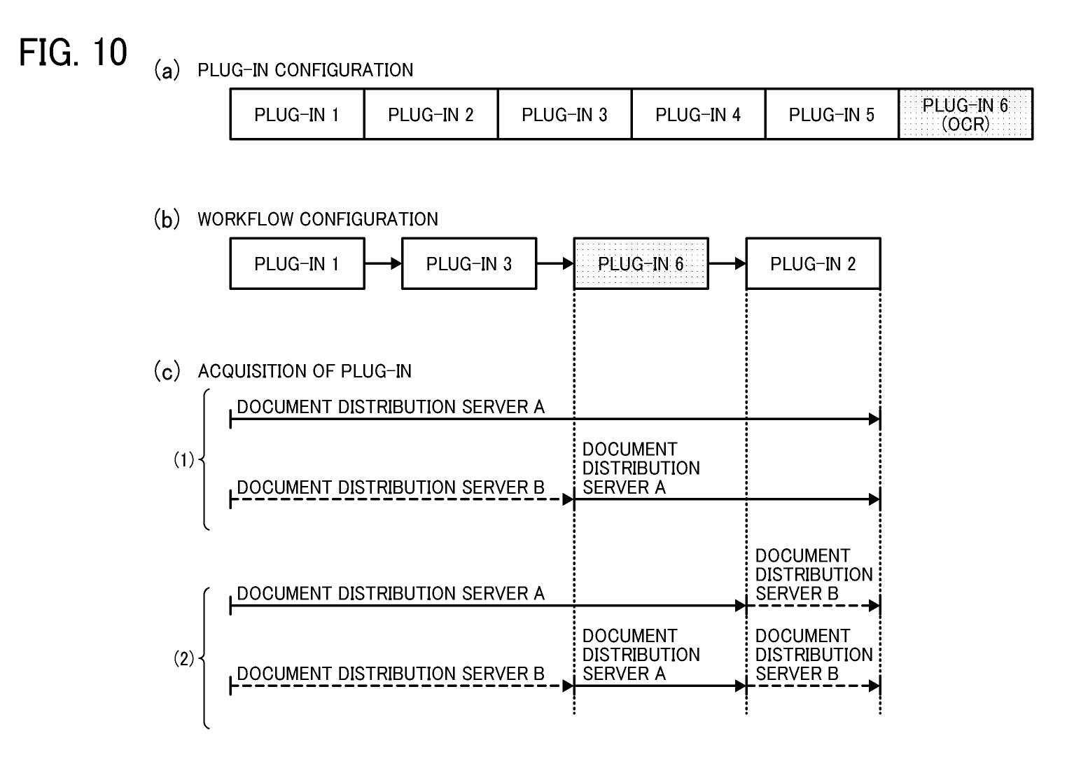

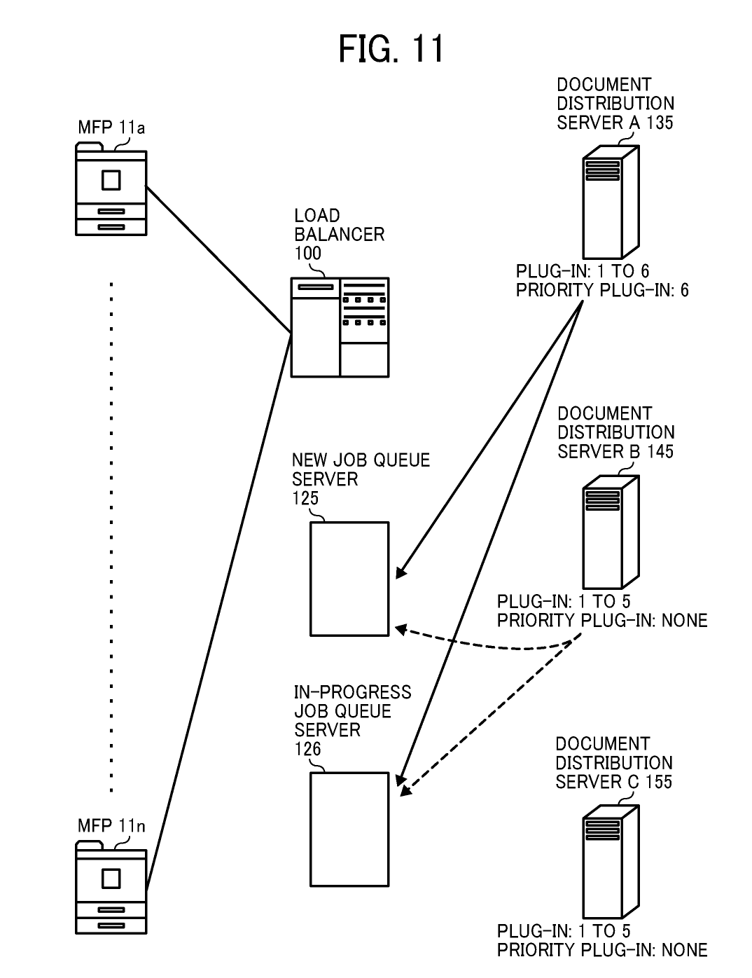

FIG. 10 is an exemplary illustration for explaining a plug-in configuration, a workflow configuration, and the document distribution servers A and B undertaking processing to be executed by the plug-ins according to the embodiment of the present invention. FIG. 11 is an exemplary illustration for explaining types of the job queue servers accessed by the document distribution servers A and B according to the exemplary embodiment of the present invention. More specifically, in this embodiment, the job queue servers include a new job queue server 125 and an in-progress job queue server 126 as illustrated in FIG. 11.

As illustrated in (a) of FIG. 10, the plug-in is configured by the plug-ins 1 to 6. The plug-in 6 is a plug-in for executing the OCR processing. The execution of the OCR processing by the plug-in 6 takes longer than any one of the processes by the plug-ins 1 to 5. Therefore, the processing by the plug-in 6 is set as the priority acquisition job.

As illustrated in (b) of FIG. 10, the workflow is processing that executes the plug-in 1, the plug-in 3, the plug-in 6, and the plug-in 2 in sequence. In other words, the plug-ins 1 and 3 precede the priority plug-in 6, and the plug-in 2 follows the priority plug-in 6 in the workflow.

As illustrated in (c) of FIG. 10, the document distribution servers A and B undertake processing to be executed by each plug-in constituting the workflow illustrated in (b) of FIG. 10 in two different manners. Further, as illustrated in FIG. 11, the document distribution servers A and B each accesses either the new job queue server 125 or the in-progress job queue server 126.

A load balancer 100 illustrated in FIG. 11 receives the job, which is a request for executing the workflow, from each of MFPs 11. The load balancer 100 registers the received jobs in a job queue. In other words, the load balancer functions as a receiver for receiving the job from the MFP 11.

The new job queue server 125 registers, in a queue, the plug-ins of a job (that is, the job for instructing execution of a workflow), which have not yet acquired by either the document distribution server A or B. In other words, in response to receiving the request for executing the workflow from the MFP 11, the load balancer 100 registers the job of the requested workflow in the new job queue server 125. The in-progress job queue server 126 registers, in a queue, an unfinished job having the unfinished workflow. Such unfinished workflow includes at least one plug-in which remains unexecuted after the document distribution server A and/or B acquire the job and executes each plug-in constituting the workflow instructed by the job. In other words, the in-progress job queue server 126 registers the job in which only a part of a plurality of processes constituting the workflow has been executed.

As described above, the document distribution server A includes the plug-ins 1 to 5 and the priority plug-in 6. Accordingly, as illustrated in (c) (1) of FIG. 10, the document distribution server A is able to undertake processes of all of the plug-ins from the start to the end of the workflow (from the plug-in 1 till the plug-in 2). Accordingly, the document distribution server A may first access the new job queue server 125 to execute the entire processing of the workflow.

In the meantime, as illustrated in FIG. 11, the document distribution server B includes the plug-ins 1 to 5, while it does not include the plug-in 6, which is the priority plug-in. Thus, the document distribution server B is able to undertake the processes of the plug-ins 1 and 3 when the workflow is started. Accordingly, the document distribution server B may first access the new job queue server 125 to execute the processing of the workflow from the plug-in 1 till plug-in 3. Subsequently, the document distribution server B registers, in the in-progress job queue server 126, a result obtained by executing the processes of up to the plug-in 3 and information indicating that the workflow from the plug-in 6 onward remains unexecuted. In this case, the document distribution server A accesses the in-progress job queue server 126 to undertake the processes of the remaining plug-in 6 and plug-in 2 to execute the processing of the workflow as illustrated in (c) (1) of FIG. 10.

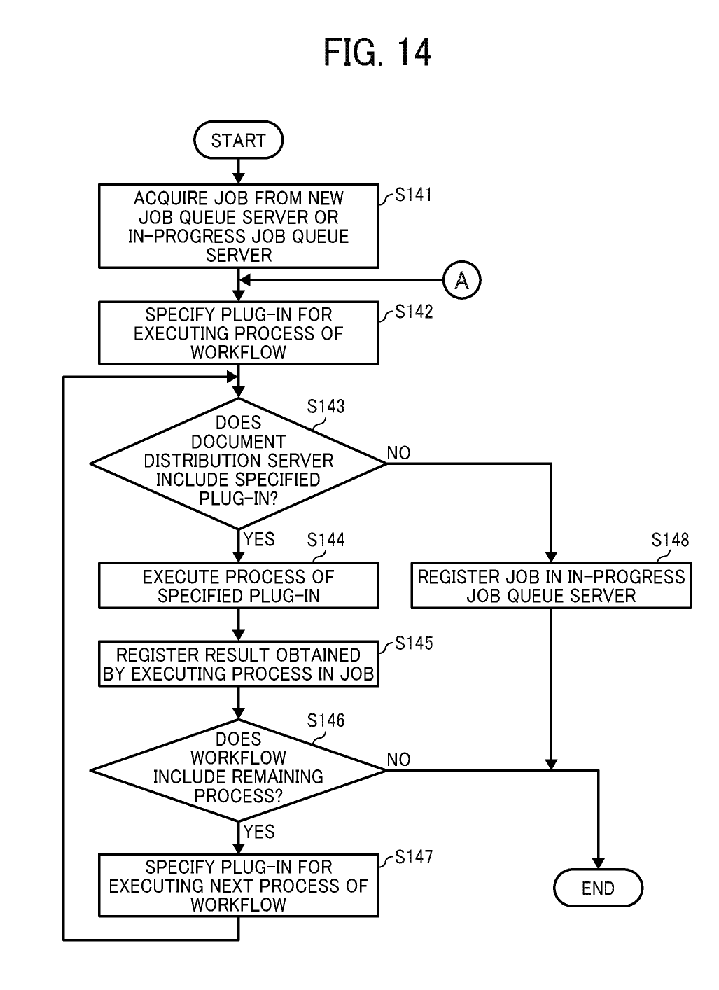

FIG. 14 is a flowchart illustrating an operation performed by each of the document distribution server A and the document distribution server B when undertaking the processes of the workflow as illustrated in (c) (1) of FIG. 10.

At S141, the document distribution server A acquires the job from the new job queue server 125 or the in-progress job queue server 126. At S142, the document distribution server A specifies the plug-in for executing the process of the workflow instructed by the acquired job. At S143, the document distribution server A determines whether the document server A includes the plug-in specified at S142. At S144, the document distribution server A executes the process of the specified plug-in based on a determination indicating that the document distribution server A includes the specified plug-in (S143: YES). At S145, the document distribution server A registers a result obtained by executing the process of the specified plug-in in the job. At S146, the document distribution server A determines whether the workflow includes a remaining process or processes. When the determination indicates that the workflow includes the remaining process or processes (S146: YES), at S147, the document distribution server A specifies the plug-in for executing a next process (i.e., a first process in the remaining process or processes). Then, the processing returns to S143 to repeat S143 to S146 for the remaining process or processes. When the determination indicates that the workflow does not include the remaining process (S146: NO), the operation ends.

When the determination indicates that the document distribution server A does not include the specified plug-in (S143: NO), the document distribution server A registers the job in the in-progress job queue server 126 (S148), and the operation ends.

The document distribution server B undertakes the processing of the workflow in a substantially same manner as the document distribution server A. More specifically, for the plug-in 6, the document distribution server B determines that the document distribution server B does not include the specified plug-in (S143: NO), and registers the job in the in-progress job queue server 126 (S148).

Because the document distribution server A includes the priority plug-in 6 as illustrated in FIG. 11, it is able to undertake processes of all of the plug-ins 1 to 6. Accordingly, as illustrated in (c) (2) of FIG. 10, the document distribution server A may first access the new job queue server 125 to execute the workflow from the plug-in 1 till the plug-in 6. Subsequently, the document distribution server A registers, in the in-progress job queue server 126, a result obtained by executing the processes of up to the plug-in 6 and information indicating that the workflow from the plug-in 2 onward remains unexecuted. In this case, the document distribution server B accesses the in-progress job queue server 126 to undertake the process of the remaining plug-in 2 to execute the processing of the workflow.

Further, the document distribution server B includes the plug-ins 1 to 5, while it does not include plug-in 6, which is the priority plug-in. Thus, the document distribution server B is able to undertake the processes of the plug-ins 1 and 3. Accordingly, the document distribution server B may first access the new job queue server 125 to execute the processes of the workflow from the plug-in 1 till plug-in 3 as illustrated in (c) (2) of FIG. 10. Subsequently, the document distribution server B registers, in the in-progress job queue server 126, a result obtained by executing the processes of up to the plug-in 3 and information indicating that the workflow from the plug-in 6 onward remains unexecuted.

In this case, the document distribution server A accesses the in-progress job queue server 126 to undertake the process of the remaining plug-in 6 to execute the processing of the workflow. Subsequently, the document distribution server A registers, in the in-progress job queue server 126, a result obtained by executing the process of the plug-in 6 and information indicating that the workflow from the plug-in 2 onward remains unexecuted. In this case, the document distribution server B further accesses the in-progress job queue server 126 to undertake the process of the remaining plug-in 2 to execute the processing of the workflow.

In other words, in this exemplary embodiment, the document distribution server A may undertake the processes of the workflow from the plug-in 1 till plug-in 2 as illustrated in (c) (1) of FIG. 10. Alternatively, the document distribution server A may undertake the processes of the workflow from the plug-in 1 till the plug-in 6, that is, until the plug-in that is included only in the distribution server A finishes processing, as illustrated in (c) (2) of FIG. 10.

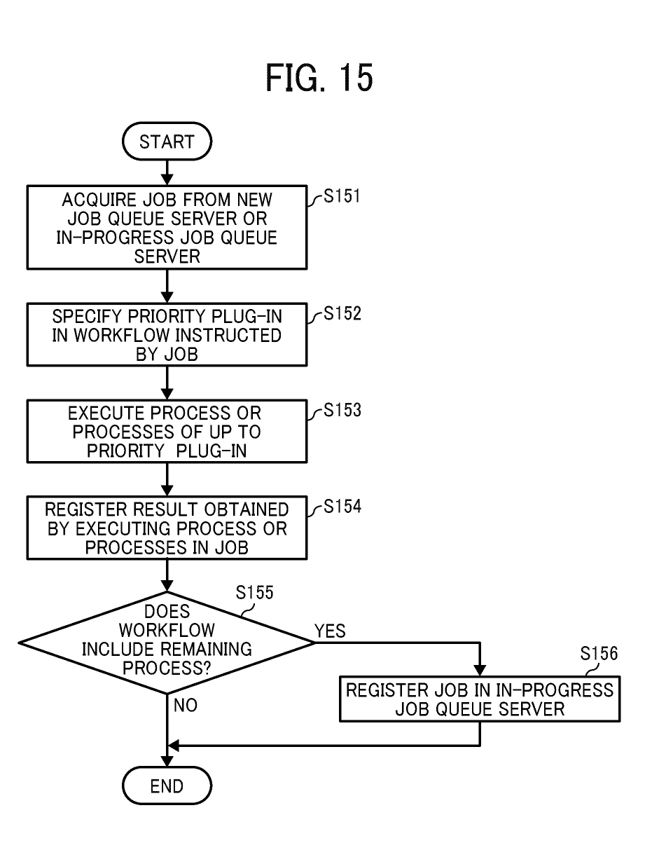

FIG. 15 is a flowchart illustrating an operation performed by the document distribution server A when undertaking the processes of the workflow as illustrated in (c) (2) of FIG. 10.

At S151, the document distribution server A acquires the job from the new job queue server 125 or the in-progress job queue server 126. At S152, the document distribution server A specifies the priority plug-in in the workflow instructed by the acquired job. At S153, the document distribution server A executes the process or processes of up to the specified priority plug-in. At S154, the document distribution server A registers a result obtained by executing the process or processes of up to the specified priority plug-in in the job. At S155, the document distribution server A determines whether the workflow includes a remaining process. When a determination indicates that the workflow includes the remaining process (S155: YES), at S156, the document distribution server A registers the job in the in-progress job queue server 126, without performing the remaining process. Then, the operation ends. When the determination indicates that the workflow does not include the remaining process (S155: NO), the operation ends, without registering the job in the in-progress job queue server 126.

The document distribution server B undertakes the processing of the workflow in a substantially same manner as described above with reference to FIG. 14.

As described above, the priority workflow execution processor (e.g., the document distribution server A) may undertake the processes of the priority plug-in 6, the normal plug-in that precedes the priority plug-in 6, and the normal plug-in that follows the priority plug-in 6. Alternatively, the priority workflow execution processor may undertake the processes of the priority plug-in 6 and the normal plug-in that precedes the priority plug-in 6. Further alternatively, the priority workflow execution processor may undertake the process of only the priority plug-in 6. In the meantime, the document distribution server B as the normal workflow execution processor may undertake the process of at least the normal plug-in other than the priority plug-in 6.

In executing workflow processing, when the document distribution server B (referred to as “light-processing equipment” hereinafter) that does not have the plug-in for executing heavy load processing such as the process of the priority plug-in 6, and the document distribution server A (referred to as “heavy-processing equipment” hereinafter) that has at least the priority plug-in, are present, it is desirable to distribute the processes so that the workflow processing is performed most efficiently. In view of this, the light-processing equipment determines whether to acquire the workflow from the new job queue server 125 based on a determination of whether the light-processing equipment itself is able to execute up to the Nth plug-in, where N is a natural number.

When the light-processing equipment determines that it is able to execute the processes of the first to Nth plug-ins, it acquires the workflow to execute the processes till the Nth plug-in. In a case where the processing load of the first plug-in (N=1) is heavy, the heavy-processing equipment will be responsible for executing such processing. In such case, the heavy—processing equipment will take the new job to perform, for example, up to the end, such that the light-processing equipment may not always execute the processing till the Nth plug-in. Further, when the processing of the workflow terminates midway, the light-processing equipment registers the remaining workflow in the in-progress job queue server 126. Thus, in a case where the light-processing equipment does not undertake the process of the subsequent plug-in, the light-processing equipment confirms that it is not able to execute such plug-in and registers the unexecuted plug-in in the in-progress job queue server 126.

In the meantime, in a case where there is registered the workflow in the in-progress job queue server 126, the heavy-processing equipment undertakes the process of the remaining plug-in from the in-progress job queue server 126 to execute the processing of the workflow. In a case where there is registered no workflow in the in-progress job queue server 126, the heavy-processing equipment acquires the workflow from the new job queue server 125 to execute processing of the plug-in.

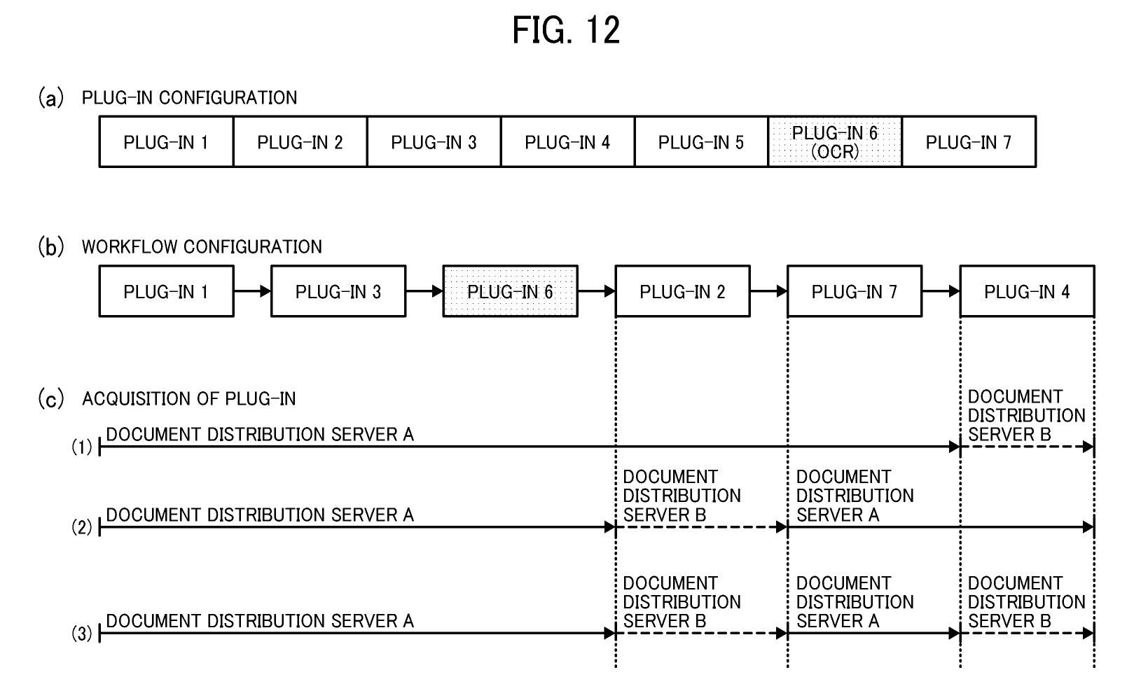

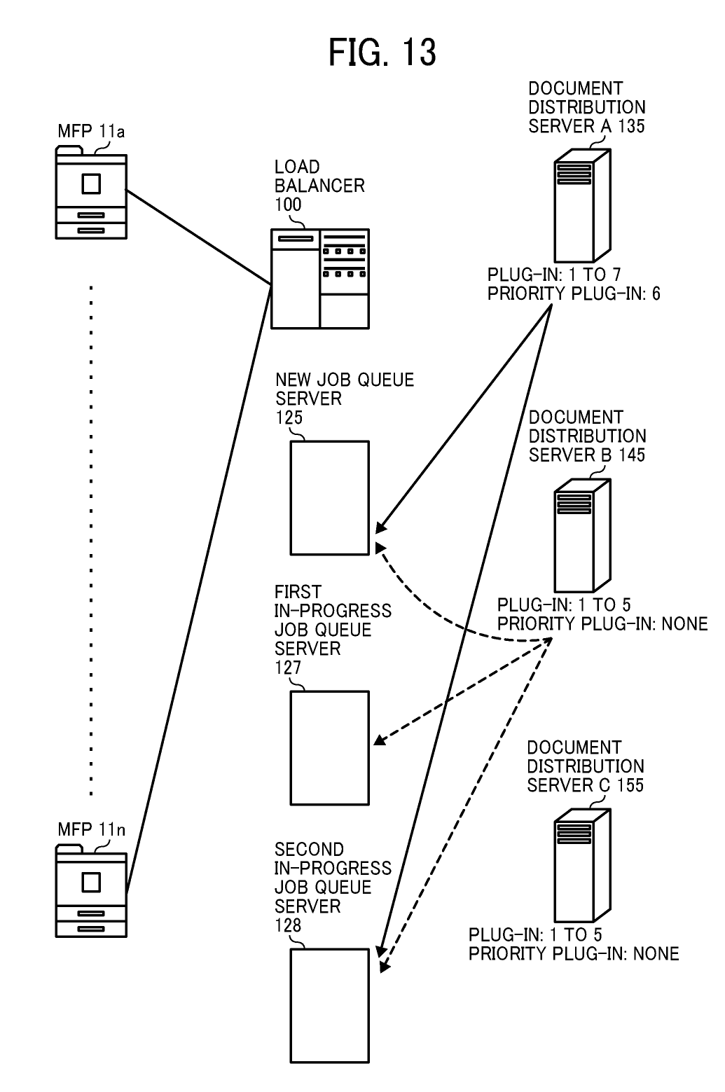

Referring to FIGS. 12 and 13, explanation will be made of a plug-in configuration, a workflow configuration, and the document distribution servers A and B undertaking processing to be executed by the plug-ins in the workflow execution system 10 according to a further exemplary embodiment of the present invention. Further, explanation will be made of types of the job queue servers accessed by the document distribution servers A and B according to a further exemplary embodiment of the present invention. More specifically, in this embodiment, the job queue servers include the new job queue server 125, a first in-progress job queue server 127, and a second in-progress job queue server 128.

FIG. 12 is an exemplary illustration for explaining a plug-in configuration, a workflow configuration, and the document distribution servers A and B undertaking the processing to be executed by the plug-in in the workflow execution system 10 according to a further exemplary embodiment of the present invention. FIG. 13 is an exemplary illustration for explaining types of the job queue servers accessed by the document distribution servers A and B according to the exemplary embodiment of the present invention.

As illustrated in (a) of FIG. 12, the plug-in is configured by the plug-ins 1 to 7. The plug-in 6 is a plug-in for executing the OCR processing. The execution of OCR processing by the plug-in 6 takes longer than any one of the processes by the plug-ins 1 to 5 and 7. Therefore, the process by the plug-in 6 is set as the priority acquisition job.

As illustrated in (b) of FIG. 12, the workflow is processing that executes the plug-in 1, the plug-in 3, the plug-in 6, the plug-in 2, the plug-in 7, and the plug-in 4 in sequence. The document distribution servers A and B undertake process to be executed by the plug-ins constituting the workflow illustrated in (b) of FIG. 12 in a manner as illustrated in (c) of FIG. 12. As illustrated in FIG. 13, the document distribution server A accesses either the new job queue server 125 or the first in-progress job queue server 128. Further, as illustrated in FIG. 13, the document distribution server B accesses either one of the new job queue server 125, the first in-progress job queue server 127, and the second in-progress job queue server 128.

Because the document distribution server A includes the plug-ins 1 to 7 including the priority plug-in 6 as illustrated in FIG. 13, it is able to undertake the processes of all of the plug-ins 1 to 7. Accordingly, as illustrated in (c) (1) of FIG. 12, the document distribution server A may first access the new job queue server 125 to execute the workflow from the plug-in 1 till the plug-in 7. Subsequently, the document distribution server A registers, in the second in-progress job queue server 128, a result obtained by executing the processes of up to the plug-in 7 and information indicating that the workflow from the plug-in 4 onward remains unexecuted.

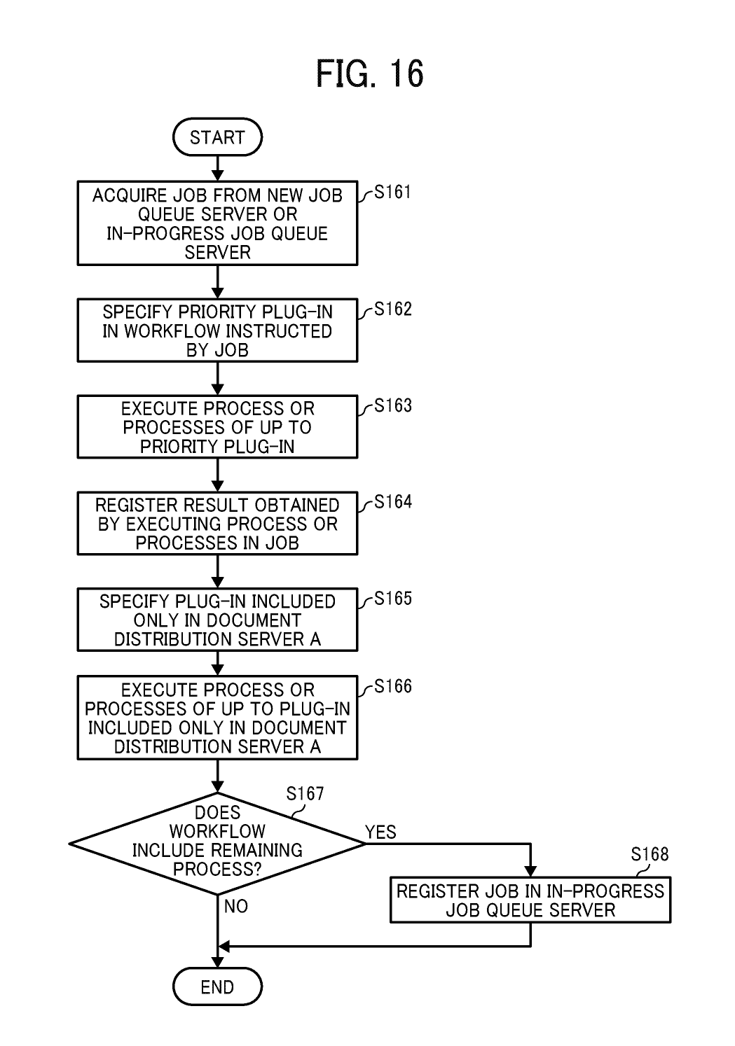

FIG. 16 is a flowchart illustrating an operation performed by the document distribution server A when undertaking the processes of the workflow as illustrated in (c) (1) of FIG. 12.

At S161, the document distribution server A acquires the job from the new job queue server 125 or the first in-progress job queue server 127. At S162, the document distribution server A specifies the priority plug-in in the workflow instructed by the acquired job. At S163, the document distribution server A executes the process or processes of up to the specified priority plug-in. At S164, the document distribution server A registers a result obtained by executing the process or processes of up to the specified priority plug-in in the job. At S165, the document distribution server A specifies the plug-in (plug-in 7) that is included only in the document server A. At S166, the document distribution server A executes the process or processes of up to the plug-in that is included only in the document distribution server A. At S167, the document distribution server determines whether the workflow includes a remaining process. At S168, the document distribution server A registers the job in the second in-progress job queue server 128 based on a determination indicating that the workflow includes the remaining process (S167: YES). Then, the processing ends. When the determination indicates that the workflow does not include the remaining process (S167: NO), the processing ends.

In the meantime, as illustrated in FIG. 13, the document distribution server B includes the plug-ins 1 to 5, while it does not include either the plug-in 6, which is the priority plug-in, or the plug-in 7. Thus, the document distribution server B is able to undertake the process of the plug-in 4. Accordingly, the document distribution server B may first access the second in-progress job queue server 128 to undertake the process of the remaining plug-in 4.

Alternatively, as also illustrated in (c) (2) of FIG. 12, the document distribution server A may first access the new job queue server 125 to execute the workflow from the plug-in 1 till the plug-in 6. Subsequently, the document distribution server A registers, in the second in-progress job queue server 128, a result obtained by executing the processes of up to the plug-in 6 and information indicating that the workflow from the plug-in 2 onward remains unexecuted.

Then, the document distribution server B accesses the second in-progress job queue server 128 to undertake the process of the remaining plug-in 2 to execute the workflow. Subsequently, the document distribution server B, which does not include the plug-in 7, registers, in the first in-progress job queue server 127, a result obtained by executing the process of the plug-in 2 and information indicating that the workflow from the plug-in 7 onward remains unexecuted.

Then, the document distribution server A further accesses the first in-progress job queue server 127 to undertake the processes of the remaining plug-ins 7 and 4 to execute the workflow.

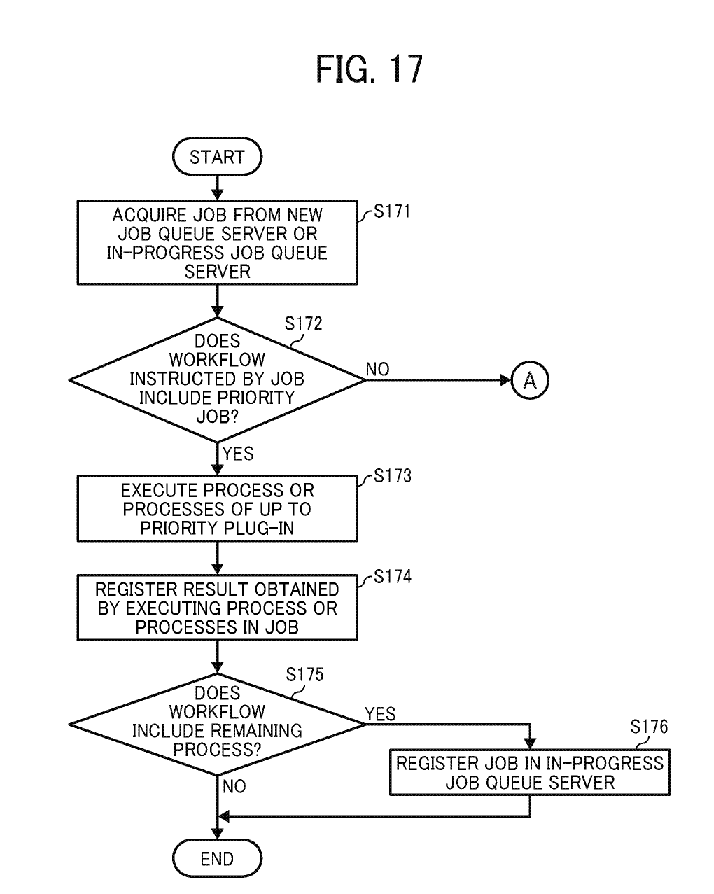

FIG. 17 is a flowchart illustrating an operation performed by the document distribution server A when undertaking the processes of the workflow as illustrated in (c) (2) of FIG. 12.

At S171, the document distribution server A acquires the job from the new job queue server 125 or the first in-progress job queue server 127. At S172, the document distribution server A determines whether the workflow instructed by the acquired job includes the priority job. At S173, the document distribution server A executes the process or processes of up to the specified priority plug-in based on a determination indicating that the workflow includes the priority plug-in (S172: YES). At S174, the document distribution server A registers a result obtained by executing the process or processes of up to the specified priority plug-in in the job. At S175, the document distribution server A determines whether the workflow includes a remaining process. At S176, the document distribution server A registers the job in the second in-progress job queue server 128 based on a determination indicating that the workflow includes the remaining process (S175: YES). Then, the processing ends. When the determination indicates that the workflow does not include the remaining process (S175: NO), the processing ends without registering the job in the second in-progress job queue server 128.

When the determination indicates that the workflow does not include the priority plug-in (S172: NO), the document distribution server A performs the operations from S142 to S147 of FIG. 14.

Further alternatively, as also illustrated in (c) (3) of FIG. 12, the document distribution server A may first access the new job queue server 125 to execute the workflow from the plug-in 1 till the plug-in 6. Subsequently, the document distribution server A registers, in the second in-progress job queue server 128, a result obtained by executing the processes of up to the plug-in 6 and information indicating that the workflow from the plug-in 2 onward remains unexecuted.

Then, the document distribution server B accesses the second in-progress job queue server 128 to undertake the process of the remaining plug-in 2 to execute the workflow. Subsequently, the document distribution server B, which does not include the plug-in 7, registers, in the first in-progress job queue server 127, a result obtained by executing the process of the plug-in 2 and information indicating that the workflow from the plug-in 7 onward remains unexecuted.

Then, the document distribution server A further accesses the first in-progress job queue server 127 to undertake the process of the remaining plug-in 7 to execute the workflow. As described above, both the document distribution server A and the document distribution server B include the plug-in 4. Accordingly, the document distribution server A registers, in the second in-progress job queue server 128, a result obtained by executing the process of the plug-in 7 and information indicating that the workflow from the plug-in 4 onward remains unexecuted. In this case, the document distribution server B accesses the second in-progress job queue server 128 to undertake the process of the remaining plug-in 4 to execute the workflow.

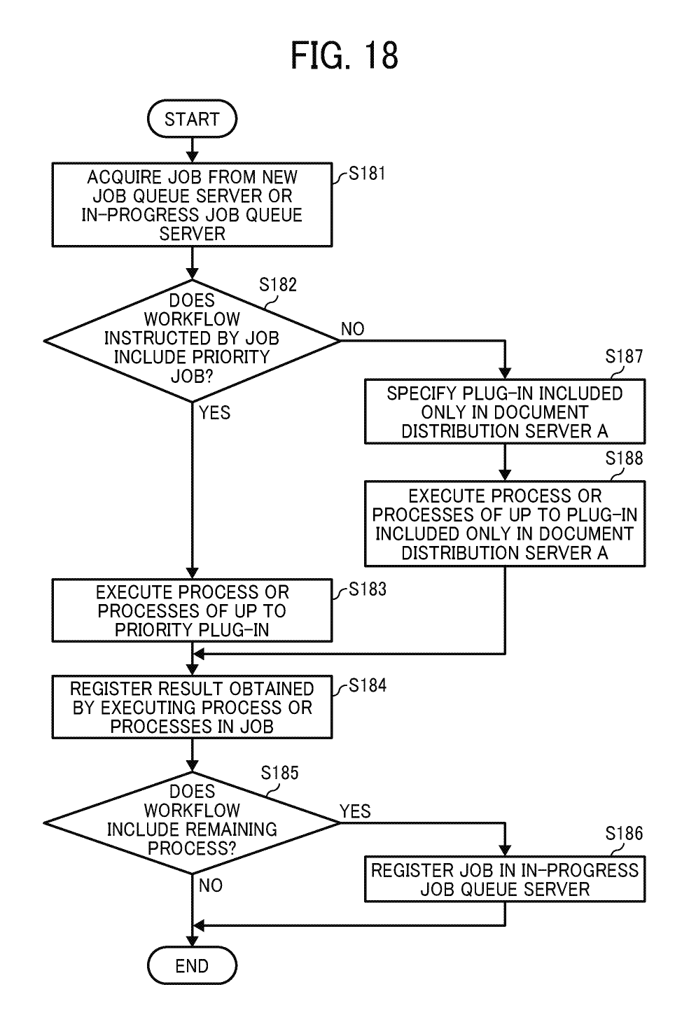

FIG. 18 is a flowchart illustrating an operation performed by the document distribution server A when undertaking the processes of the workflow as illustrated in (c) (3) of FIG. 12.

At S181, the document distribution server A acquires the job from the new job queue server 125 or the first in-progress job queue server 127. At S182, the document distribution server A determines whether the workflow instructed by the acquired job includes the priority plug-in. At S183, the document distribution server A executes the process or processes of up to the priority plug-in based upon a determination indicating that the workflow includes the priority plug-in (S182: YES). At S184, the document distribution server registers a result obtained by executing the process or processes in the job. When the determination indicates that the workflow does not include the priority plug-in (S182: NO), the document distribution server A specifies the plug-in that is included only in the document server A (S187). At S188, the document distribution server A executes the process or processes of up to the plug-in that is included only in the document server A. At S185, the document server determines whether the workflow includes a remaining process. At S186, the document distribution server A registers the job in the second in-progress job queue server 128 based on a determination indicating that the workflow includes the remaining process (S185: YES). Then, the processing ends. When the determination indicates that the workflow does not include the remaining process (S185: NO), the processing ends without registering the job in the second in-progress job queue server 128.

In other words, in this exemplary embodiment, the document distribution server A may acquire the workflow from the plug-in 1 till plug-in 7, which is the last plug-in among the plug-ins included in the document distribution server A. Alternatively, the document distribution server A may acquire the workflow from the plug-in 1 till the plug-in 6, which is a plug-in included only in the document distribution server A, and the plug-in 7 and onward. Further alternatively, the document distribution server A may acquire the workflow from the plug-in 1 till the plug-in 6, and the plug-in 7.

As described above, the document distribution server A may acquire the processes of the priority plug-in 6 and the plug-in other than the priority plug-in collectively. Alternatively, the document distribution server A may acquire the processes of the priority plug-in 6 and the plug-in 7 collectively or individually. Further, the document distribution server A may acquire the process of the plug-in 7 and the process of the plug-in other than the plug-in 7. In the meantime, the document distribution server B may acquire the process of at least the plug-in other than the priority plug-in 6 and the plug-in 7.

In executing workflow processing, the heavy-processing equipment may be installed with a plug-in of which processing the light-processing equipment cannot execute as well as a plug-in of which process the light-processing equipment also can execute. When executing the workflow, the heavy-processing equipment determines whether subsequent processing includes a process of the plug-in which the light-processing equipment cannot execute. Based on the determination, the heavy-processing equipment execute the process of the last plug-in among the plug-ins which only the heavy-processing equipment can execute. Further, when the processing of the workflow terminates midway, the heavy-processing equipment registers, in the second in-progress job queue server 128, a result obtained by executing the process of the last plug-in and information indicating that the subsequent workflow remains unexecuted.

The light-processing equipment accesses the second in-progress job queue server 128 to acquire the process of the plug-in, in a case where there is registered a workflow in the second in-progress job queue server. In a case where there is registered no workflow in the second in-progress job queue server 128, the light-processing equipment determines whether to acquire the workflow from the new job queue server 125. In other words, the light-processing equipment transits to the process of the above described exemplary embodiment. Further, when the processing of the workflow terminates midway, the light-processing equipment registers, in the first in-progress job queue server 127, a result obtained by executing the process of the acquired plug-in and information indicating that the subsequent workflow remains unexecuted.

As described above in some exemplary embodiments, a distribution server as a node acquires a job from a job queue without requiring a load balancer to assign the job to the node. Accordingly, calculation of loads is not required. Further, a mistake in selecting a node, such as assigning the job to an overloaded node, may be prevented. Accordingly, loads on the nodes are distributed efficiently with a simple configuration.

The operational flows of the workflow execution system according to an exemplary embodiment of the present invention as illustrated in FIGS. 4, 6 and 8 may be executed by a program on a computer. In other words, the CPU 201 in the job queue DB 12, and the distribution servers 13 and 14 loads a program stored in the ROM 203 to perform various operation as described above according to the loaded program.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A workflow execution control system, comprising:
a job queue server configured to store a plurality of jobs in a memory; and
a plurality of distribution servers each being set with job acquisition setting and each configured to:
acquire one of the plurality of jobs from the job queue server based on a determination of whether the job acquisition setting indicates that the job queue server is a job queue server that the distribution server is to acquire the job from;
determine whether a predetermined job is included in the acquired job according to the job acquisition setting indicating the predetermined job to be processed by the distribution server; and
execute the predetermined job based on a determination indicating that the acquired job includes the predetermined job.

2. The workflow execution control system according to claim 1, wherein the distribution server accesses the job queue server every predetermined time period that is set with the job acquisition setting.

3. The workflow execution control system according to claim 1, wherein the plurality of distribution servers includes at least a first distribution server and a second distribution server, the first distribution server being set with the job acquisition setting that further indicates a priority job including a specific processing to be processed in priority, the second distribution server being set with the job acquisition setting that does not indicate the priority job, and
the first distribution server acquires one of the plurality of jobs from the job queue server, which is the priority job including the specific processing to be processed in priority that is indicated by the job acquisition setting.

4. The workflow execution control system according to claim 3, wherein the first distribution server further determines whether the priority job is included in the acquired job, and executes the priority job prior to other acquired job.

5. The workflow execution control system according to claim 1, wherein the job queue server further includes circuitry configured to send a notification for requesting acquisition of a job to a predetermined destination every time the job is registered in the memory, the predetermined destination including at least the distribution server, and
wherein the distribution server acquires the job in response to the notification.

6. The workflow execution control system according to claim 3, wherein
the job instructs an execution of a workflow including a plurality of plug-ins arranged in an order, and
when the workflow includes a priority plug-in that is set as the priority job including the specific processing, the first distribution server acquires the priority job to undertake processing of the priority plug-in.

7. The workflow execution control system according to claim 6, wherein, when the workflow further includes a normal plug-in in addition to the priority plug-in,
the first distribution server determines whether the normal plug-in precedes the priority plug-in in the workflow, and acquires the priority job to undertake the processing of the normal plug-in and the processing of the priority plug-in based on a determination indicating that the normal plug-in precedes the priority plug-in.

8. The workflow execution control system according to claim 6, wherein, when the workflow includes a normal plug-in in addition to the priority plug-in,
the first distribution server determines whether the workflow has the normal plug-in preceding the priority plug-in and the normal plug-in following the priority plug-in, and acquires the priority job to undertake the processes of all of the plug-ins in the workflow.

9. The workflow execution control system according to claim 6, wherein, when the the workflow includes a normal plug-in in addition to the priority plug-in,
the first distribution server determines whether the workflow has the normal plug-in preceding the priority plug-in and the normal plug-in following the priority plug-in, and acquires the priority job to undertake the processing of the normal plug-in preceding the priority plug-in and the processing of the priority plug-in, and
the second distribution server undertakes the processing of the normal plug-in following the priority plug-in.

10. The workflow execution control system according to claim 9, wherein, when the workflow includes the normal plug-in preceding the priority plug-in and the normal plug-in following the priority plug-in, the second distribution server undertakes the processing of the normal plug-In preceding the priority plug-in, and
the first distribution server undertakes the processing of the priority plug-in and the processing of the normal plug-in following the priority plug-in.

11. The workflow execution control system according to claim 9, wherein, when the workflow includes the normal plug-in preceding the priority plug-in and the normal plug-in following the priority plug-in,
the second distribution server undertakes the processing of the normal plug-in preceding the priority plug-in,
the first distribution server undertakes the processing of the priority plug-in, and
the second distribution server undertakes the processing of the normal plug-in following the priority plug-in.

12. The workflow execution control system according to claim 9, further comprising an in-progress job queue server,
wherein the first distribution server registers, in the in-progress job queue server, a result obtained by executing the processing of the normal plug-in preceding the priority plug-in and the processing of the priority plug-in and information indicating that the processing of the normal plug-In following the priority plug-in has not yet been undertaken.

13. The workflow execution control system according to claim 10, further comprising an in-progress job queue server,
wherein the second distribution server registers, in the in-progress job queue server, a result obtained by executing the processing of the normal plug-in preceding the priority plug-in and information indicating that the processing of the priority plug-in and the processing of the normal plug-in following the priority plug-in have not yet been undertaken.

14. The workflow execution control system according to claim 11, further comprising an in-progress job queue server,
wherein the second distribution server registers, in the in-progress job queue server, a result obtained by executing the processing of the normal plug-in preceding the priority plug-in and information indicating that the processing of the priority plug-in and the processing of the normal plug-In following the priority plug-in have not yet been undertaken, and
the first distribution server, registers, in the in-progress job queue server, a result obtained by executing the processing of the priority plug-in and the information indicating that the processing of the normal plug-in following the priority plug-in has not yet been undertaken.

15. The workflow execution control system according to claim 12, further comprising a new job queue server,
wherein
the first distribution server undertakes, from the new job queue server, the processing of the normal plug-in preceding the priority plug-in and the processing of the priority plug-in,
the first distribution server registers, in the in-progress job queue server, the result obtained by executing the processing of the normal plug-in preceding the priority plug-in and the processing of the priority plug-in and the information indicating that the processing of the normal plug-in following the priority plug-in has not yet been undertaken, and
the second distribution server undertakes, from the in-progress job queue server, the processing of the normal plug-in following the priority plug-in.

16. The workflow execution control system according to claim 13, further comprising a new job queue server,
wherein
the second distribution server undertakes, from the new job queue server, the processing of the normal plug-in preceding the priority plug-in,
the second distribution server registers, in the in-progress job queue server, the result obtained by executing the processing of the normal plug-in preceding the priority plug-in and the information indicating that the processing of the priority plug-in and the processing of the normal plug-in following the priority plug-in have not yet been undertaken, and
the first distribution server undertakes, from the in-progress job queue server, the processing of the priority plug-in and the processing of the normal plug-in following the priority plug-in.

17. The workflow execution control system according to claim 14, further comprising a new job queue server,
wherein
the second distribution server undertakes, from the new job queue server, the processing of the normal plug-in preceding the priority plug-in,
the second distribution server registers, in the in-progress job queue server, the result obtained by executing the processing of the normal plug-in preceding the priority plug-in and the information indicating that the processing of the priority plug-in and the processing of the normal plug-in following the priority plug-in have not yet been undertaken,
the first distribution server undertakes, from the in-progress job queue server, the processing of the priority plug-in,
the first distribution server registers, in the in-progress job queue server, the result obtained by executing the processing of the priority plug-in and the information indicating that the processing of the normal plug-in following the priority plug-in has not yet been undertaken, and
the second distribution server undertakes, from the in-progress job queue server, the processing of the normal plug-in following the priority plug-in.

18. A method for controlling execution of a workflow, performed by a workflow execution processor coupled to a storage device, the method comprising:
storing, in a memory, job acquisition setting, the job acquisition setting indicating a specific storage device from which the workflow execution processor acquires a job from and a predetermined job to be processed by the workflow execution processor;
acquiring one of a plurality of jobs from the storage device according to the job acquisition setting; and
executing the predetermined job based on a determination indicating that the acquired job includes the predetermined job, according to the job acquisition setting.

19. A non-transitory recording medium storing a program for causing one or more computers to perform a method comprising:
storing, in a memory, job acquisition setting, the job acquisition setting indicating a specific storage device from which the workflow execution processor acquires a job from and a predetermined job to be processed by the workflow execution processor;
acquiring one of a plurality of jobs from the storage device according to the job acquisition setting; and
executing the predetermined job based on a determination indicating that the acquired job includes the predetermined job, according to the job acquisition setting.
